(19) United States
(12) Patent Application Publication
(10) Pub. No.: US 2021/0196573 A1
(43) Pub. Date: Jul. 1, 2021

(54) METERING DEVICE

(71) Applicant: Ingmar Wellach, Hamburg (DE)

(72) Inventor: Ingmar Wellach, Hamburg (DE)

(21) Appl. No.: 17/057,789

(22) PCT Filed: May 24, 2019
(86) PCT No.: PCT/DE2019/200046

§ 371 Date: Nov. 23, 2020

(30) Foreign Application Priority Data
May 25, 2018 (DE) 10 2018 112 608.5

(51) Int. Cl. A61J 7/00; A61J 7/04

(52) U.S. Cl. CPC A61J 7/0046; A61J 7/0481; A61J 2200/76; A61J 7/0445; A61J 7/0418

(57) ABSTRACT

A metering device for a drinking vessel for dispensing a liquid from the drinking vessel, with a control device which detects and/or controls the delivery of the liquid. Furthermore, the invention relates to a drinking bottle having such a metering device. The drinking bottle is particularly suitable for administering a Levodopa suspension for the high-frequency treatment of idiopathic Parkinson's disease.

The invention relates to a metering device and a drinking vessel with such a metering device.

Drinking vessels are known in various designs. Now that it has been established that regular liquid intake is beneficial for human health, drinking vessels have become widespread. Drinking vessels can therefore serve in the daily supply of liquids.

However, taking a certain amount of liquid every day is not always easy. Often people find it difficult to drink enough. This is especially true for the elderly and sick. DE 20 2017 003 569 U1 therefore discloses an arrangement for the controlled, timely intake of liquids, with which it is possible to provide a reminder to take liquids. The person concerned should then reach for their drinking vessel and drink some liquid. After the liquid intake, it is then determined how large the amount was and what additional amount still has to be taken in. To do this, the drinking vessel must be placed on a scale every time. There is no limitation of the liquid intake by technical means. So it is up to the person how much liquid they take in.

In addition, it has proven useful to provide drinking vessels with a closure, with the help of which the liquid flow can be changed. For example, the flow rate can be influenced or the flow can be adapted to the viscosity of the liquid. A corresponding drinking vessel closure is described in DE 10 2010 049 727 B4. Even with this closure, however, the absolute amount of liquid that a person can intake is not limited.

The intake of a defined amount of liquid is especially important when the liquid is an active ingredient or the liquid contains such an active ingredient such as a drug. This is especially true for levodopa.

Levodopa (C₉H₁₁NO₄), also L-dopa, is the abbreviation for L-3,4-dihydroxyphenylalanine, a non-proteinogenic α-amino acid that is formed in the body from tyrosine with the help of the enzyme tyrosine hydroxylase. It occurs as a white, crystalline powder that is sparingly soluble in water. Levodopa can be converted into the active neurotransmitter dopamine by decarboxylation in the central nervous system. Levodopa is used to treat Parkinson's disease. This is intended to increase the dopamine concentration in the basal cells of the cerebrum.

Parkinson's disease (PD) is one of the most common chronic neurological diseases, in the course of which there are usually fluctuations in activity (so-called motor and non-motor activity fluctuations) after a few years. This can be caused by disturbances in the transport and absorption of the medication in the gastrointestinal tract. Various pharmacological developments in the past have aimed to positively influence the transport and absorption problems in the gastrointestinal tract (delayed or sustained, e.g. ideally continuous forms of application such as extended release (ER)), plaster formulations, so called PEN applications or pump systems). Standard therapy (gold standard) for idiopathic Parkinson's disease is still levodopa in a fixed combination with a so-called decarboxylase inhibitor (carbidopa or benserazide).

Escalation therapies are also suitable for treating PD in advanced stages. These therapies are all invasive and include enteral levodopa/carbidopa therapy via an enterally located invasive gastric tube (so-called PEG with Jet-PEG), via which an L-Dopa gel (so-called LCIG therapy=Duodopa®) is permanently is applied, as well as a subcutaneously applied soluble dopamine agonist therapy (apomorphine, e.g. APO-Go®) and the so-called deep brain stimulation (TIIS=brain pacemaker). The problems with these therapies are, however, in addition to the considerable effort and the sometimes very high therapy costs, but above all because of the invasiveness of the methods mentioned above. Enteral Duodopa® therapy in particular can lead to vital complications such as injury to abdominal organs, peritonitis, etc. In chronic use, patients are at risk from incorrect probe positions, repeated endoscopic procedures and enteral absorption disorders with deficiency symptoms (including vitamin deficiency neuropathies).

The object of the present invention is therefore to provide a metering device with the aid of which precisely defined amounts of liquid can be withdrawn from a drinking vessel at specific times. In addition, the dosing device should be able to form an easily manageable unit together with the drinking vessel, which in the case of frequent, e.g. hourly intake can enable this in a simple way outside of a domestic setting (while traveling).

According to the invention, the object is achieved by the subject matter of claim 1. Advantageous embodiments of the invention are described in the dependent claims.

The metering device generally serves to regulate the dispensing of the liquid from the drinking vessel. Various forms of the metering device are possible here. Ultimately, it depends on which liquids are to be dispensed. Various embodiments of the metering device are described below.

The dosing device according to the invention is particularly suitable for dosing medicament liquids, in particular for the dosed and time-controlled intake of a medicament suspension, such as a levodopa suspension for the high-frequency treatment of idiopathic Parkinson's disease. For the purposes of this application, a liquid is therefore also understood to be a suspension, which means a heterogeneous mixture of substances consisting of a liquid and finely divided solids. In particular, the liquid medium can be a medicinally used heterogeneous mixture of substances.

With the present invention, problems in treating Parkinson's disease can be prevented. For this purpose, the drinking vessel is filled, for example, with a commercially available and approved levodopa/carbidopa suspension in a fixed mixing ratio of 4:1 (e.g. 5 mg levodopa/1.25 mg carbidopa in SyrSpend®, durable and stable for 72 hours without refrigeration). This suspension can then be taken as prescribed by a doctor regardless of location. It has been shown that enteral drug absorption as continuous as possible leads to optimal treatment results (concept of continuous dopaminergic stimulation (CDS)).

Proven and tested is an “early dose” for the start of the day, a “repetitive dose”, which for example is taken every hour (“hourly dose”) and an “additional dose” that can be taken if necessary up to a defined maximum dose (e.g. 1000 mg/d). A maximum daily dose in mg can thus be selected as an additional control function. Once this maximum dose has been reached, no further liquid can be dispensed in order to thereby avoid an overdose. In this case, other therapy methods may have to be used.

Alternatively, dopaminergic solutions can also be used (e.g. soluble dopamine agonists).

The dosing device according to the invention has a control device which detects the dispensing of the liquid via sensors (for example flow or weight sensors) and can transmit corresponding signals to a display and/or evaluation unit. The amount of liquid dispensed can thus be registered and, for example, form the basis for dispensing a next dose.

The control device can control the delivery of the liquid. It converts input signals into drive movements in the dosing device. For example, a pump or a valve can be controlled, thereby releasing a defined amount of liquid or interrupting the flow of liquid.

The control device is in particular a memory-programmable control device, that is, a microcontroller with memories for the control program and the control parameters.

Finally, the control device can also be used to create a wireless connection, for example to smart phones or tablet devices, so that programming of the system or querying therapy protocols via smart phone apps (for example by the doctor, possibly also with the help of telemedical methods) is possible. On the other hand, patients can also be reminded of the scheduled intake of their medication via such modules and the correct intake can be recorded.

The drinking vessel can be made of glass, plastic or other materials. Depending on the sensitivity of the liquid, the drinking vessel can also be provided with a light protection for the liquid. A lightweight plastic vessel is inexpensive to manufacture and easy to handle. The size of the drinking vessel depends on the respective application. 200 and 500 ml vessels are preferred.

According to a preferred embodiment of the invention, the liquid is dispensed via the control device as a function of time. At specific and set times, the control device can send signals to a pump, for example, so that the pump can deliver a defined volume of liquid and make it available for delivery to a patient. On the other hand, it is possible that a liquid flow can be generated manually, for example by pressing on an elastic drinking vessel or sucking in the liquid, because at these times a valve opens and allows the liquid to flow until a defined volume of liquid is reached.

A time-dependent control can, however, also mean that predetermined time intervals are set between two drug withdrawals, so that a drug withdrawal is prevented in shorter time intervals.

According to a further embodiment of the invention, the control device is designed to generate a signal that can be detected visually and/or acoustically by the user of the drinking vessel. Such a signal can emanate from the metering device or the drinking vessel. For example, LEDs can light up in different colors and signal tones can be emitted, which indicate to the user that liquid intake is necessary or that sufficient liquid has been taken.

However, the control device can also be designed to generate an electronic signal for further processing of the delivery data in an external display device. As already stated above, in this way a wireless connection to smart phones or tablet devices can be created with the option of evaluating data or providing information regarding the patient.

According to another embodiment of the invention, the metering device has a storage chamber which is provided for portioning the liquid and which can be filled by means of a pumping process. Such a storage chamber can be located, for example, in the closing device of the drinking vessel. According to the respective programming, the storage chamber is filled with a defined amount of the liquid medium, for example via an electrically operated pump. The medium can then be removed from the storage chamber.

If the liquid is delivered directly to a person from the drinking vessel, it must be ensured that the set delivery amount of the liquid is adhered to, and in particular not exceeded. For this purpose, sensors (for example flow or weight sensors) can be provided in the dosing device, with the aid of which the amount of liquid dispensed can be recorded. The sensors transmit their signals to the control device, which detects the dispensing of the liquid and can forward corresponding signals to a display and/or evaluation unit. If the amount of liquid dispensed is registered, further program steps can be initiated, for example the person can be asked to take more liquid or the liquid dispensing is interrupted by means of a valve and a new time cycle for dispensing the next dose begins.

In a further preferred embodiment of the invention, the control device is assigned a control panel via which the volume and time parameters for the medium to be dispensed can be set. This control panel can be integrated in the closing device, as a result of which the metering device is generally easy to handle and operate. But it can also be attached to the outside of the drinking vessel. All setting parameters, including the drug concentration, can be set and/or accessed via the control panel.

The present invention also relates to a drinking vessel with a metering device.

According to a preferred embodiment of the invention, the metering device is located in the closing device of the drinking vessel. This has the advantage that the closing device, together with the dosing device, can be removed from a drinking vessel as a separate unit and, for example, combined with other drinking vessels. The closure device is preferably screwed onto the drinking vessel in a sealing manner. However, other connections are also possible, such as a bayonet lock.

The drinking vessel can have a stirrer in order to prevent particles from settling, especially before the liquid is dispensed, for example in the case of drug suspensions such as a levodopa suspension, and to produce a homogeneous as possible suspension. The agitator can be operated by an electric motor and, if necessary, can be controlled by the control device immediately before liquid is withdrawn. The agitator motor of the agitator is preferably integrated into the closing device so that the agitator shaft with the agitator elements protrudes into the drinking vessel. Such a construction allows the drinking vessel to be used anywhere.

The invention is explained in more detail below using a preferred exemplary embodiment. There is shown in

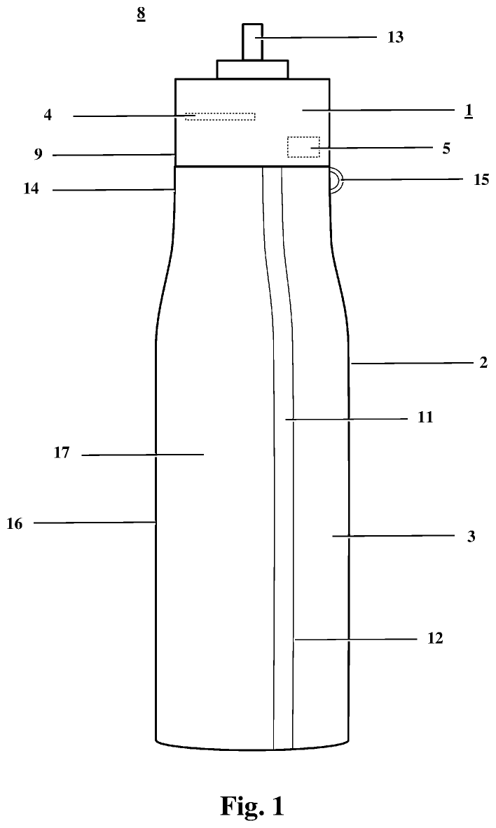

FIG. 1 a drinking vessel in a side view,

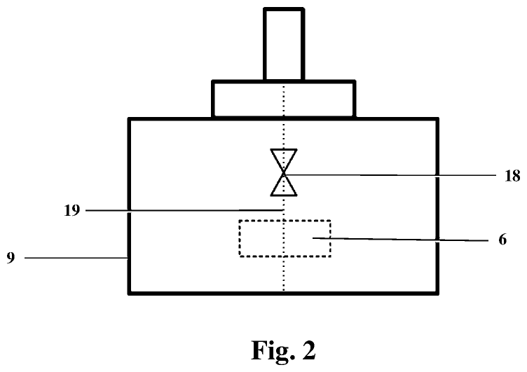

FIG. 2 a closing device in a side view

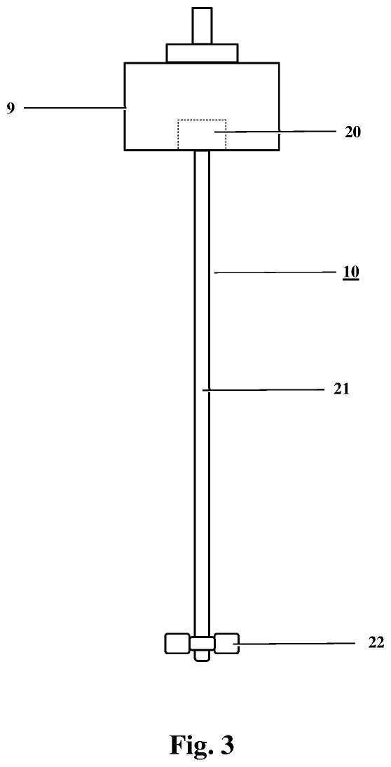

FIG. 3 a closing device with a stirrer and

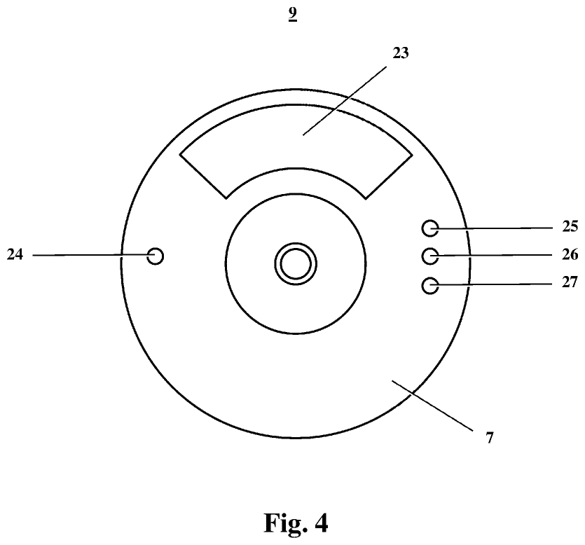

FIG. 4 a locking device with a control panel in a top view.

The drinking vessel 8 according to FIG. 1 has a drinking receptacle 2 which forms the vessel body. The drinking receptacle 2 has a cylindrical shape with a vessel neck 14 to which an eyelet 15 is attached for attaching a strap, not shown. The drinking receptacle 2 is made of plastic, for example polyethylene terephthalate (PET). As described above, however, other materials can also be considered, depending on whether the drinking receptacle 2 is a disposable or reusable drinking vessel or whether the drinking receptacle 2 should be collapsible. The drinking receptacle 2 is single-walled. However, it can also be double-walled in order to keep the temperature of the liquid as constant as possible. The wall 16 of the drinking receptacle 2 is here provided with a light protection coating 17. It has a viewing window 11 extending over the length of the drinking receptacle 2 with a display device in the form of a scale 12 in order to be able to control the filling level of the drinking receptacle 2.

The closing device 9 is designed in the form of a screw element and closes the drinking receptacle 2. It is provided with a drinking nozzle via which the liquid 3 can be dispensed. The drinking nozzle 18 can also be provided with a mouthpiece.

The control device 4 and the storage chamber 5 are located inside the closing device 9. In addition, the entire sensor system, tubing for the liquid 3, valves and devices for power supply are arranged in the closing device 9.

In FIG. 2, a closing device 9 is shown in a side view. A valve 18 controllable by the control device 4 blocks the tubing 19 for the liquid 3. In addition, a sensor 6 is provided in the form of a flow sensor, which is also connected to the control device 4.

FIG. 3 shows a closing device 9 with agitator 10. The agitator 10 is driven by an electric motor 20 and is designed with an agitator shaft 21 on which agitator elements 22 are arranged. The agitator 10 can also be connected to the control device 4.

The closing device 9 according to FIG. 4 shows the control panel 7, which has a display 23 for displaying the relevant setting parameters such as metering volume, metering times and the like. In addition, controls for example in the form of buttons 24, 25 and optical display elements in the form of LEDs 26, 27 are provided.

### Example of a Use of the Drinking Vessel

The use of the drinking vessel 8 according to the invention is explained below for the administration of a levodopa suspension for the high-frequency treatment of idiopathic Parkinson's disease.

A 500 ml drinking receptacle 2 is filled with 500 ml of a levodopa/carbidopa suspension (e.g. 1000 mg levodopa/250 mg carbidopa in 500 ml SyrSpend®=2 mg levodopa/ml). The volume and time parameters for the liquid 3 to be dispensed are then set in accordance with the medical prescription via a smart phone app or the control panel 7. So that the user cannot change the medically determined intake schedule without medical consent, a lock code can be set up here that the programming system unlocks for changes after correct code entry. For example, the following parameters are entered:

1. dose at 8:00 AM: 20-30 ml=40-60 mg L-Dopa as a starting dose

2.-14. dose every hour from 9 AM: 10-15 ml=20-30 mg per hour as a repetitive dose

15.-16. dose if required: 10-15 ml to e.g. max. 3 additional times a day

The patient is reminded to take the drug via the control panel 7 of the dosing device 1 and/or via a smart phone app. At the same time, a message can be sent to the treating doctor or the nursing staff, for example in a nursing facility. The control device 4 of the dosing device 1 then releases the set volume of the liquid 3, the levodopa suspension, at the predetermined time. In other words, the set volume is dispensed via the dosing device 1 and is available to the patient. If the medication provided is not taken, a further notification will be sent to the doctor or nursing staff. On the other hand, in the event of an additional required dose, the patient can make his own entry and call up the required dose. Since all medication administered can be recorded in this way, a therapy protocol can be created and evaluations carried out without great effort.

### LIST OF REFERENCE SYMBOLS

1 dosing device
2 drinking vessel
3 liquid
4 control device
5 storage chamber
6 sensor
7 control panel
8 drinking vessel
9 closing device
10 agitator
11 viewing window
12 scale
13 drinking nozzle
14 vessel neck
15 eyelet
16 wall
17 light protection coating
18 valve
19 tubing
20 electric motor
21 agitator shaft
22 agitator elements
23 display
24 buttons
25 buttons
26 LED
27 LED

1. A dosing device (1) for a drinking vessel (2) for dispensing a liquid (3) from the drinking vessel (2), characterized by a control device (4) which detects and/or controls the dispensing of the liquid (3).

2. The dosing device (1) according to claim 1, wherein the liquid is dispensed as a function of time via the control device (4).

3. The dosing device (1) according to claim 1, wherein the control device (4) is designed to generate a signal which the user of the drinking vessel (2) can detect visually and/or acoustically.

4. The dosing device (1) according to claim 1, wherein the control device (4) is designed to generate an electronic signal for further processing of the dispensing data in an external display device.

5. The dosing device (1) according to claim 1, wherein the dosing device (1) has a storage chamber (5) which is provided for portioning the liquid (3) and which can be filled by means of a pumping process.

6. The dosing device (1) according to claim 1, wherein the dosing device (1) has a sensor (6) via which the amount of the dispensed liquid (3) can be detected and which sends signals to the control device (4).

7. The dosing device (1) according to claim 1, wherein the control device (4) is associated with a control panel (7) via which the volume and time parameters for the medium (3) to be dispensed can be set.

8. A drinking vessel (8) with a metering device (1) according to claim 1.

9. The drinking vessel (8) according to claim 8, wherein the dosing device (1) is located in the closing device (9) of the drinking vessel (8).

10. The drinking vessel (8) according to claim 8, wherein the drinking vessel (8) has an agitator (10).
